(19) United States
(12) Patent Application Publication
(10) Pub. No.: US 2026/0330458 A1
(43) Pub. Date: Oct. 22, 2026

(54) CONDITIONAL PAYMENT, BONUS AND BIDDING SYSTEM

(71) Applicant: GrapheneHive LLC., Dallas, TX (US)

(72) Inventors: Gary FLAX, Dallas, TX (US); Ashton FLAX, Dallas, TX (US); Ella FLAX, Dallas, TX (US)

(21) Appl. No.: 19/463,176

(22) Filed: Jan. 29, 2026

Related U.S. Application Data
(60) Provisional application No. 63/751,387, filed on Jan. 30, 2025.

(51) Int. Cl. G06Q 20/40; G06Q 10/0639; G06Q 20/38; H04W 4/021

(52) U.S. Cl. CPC G06Q 20/401; G06Q 10/06398; G06Q 20/381; G06Q 20/38215; H04W 4/021

(57) ABSTRACT

A system for conditional payments and bidding includes a task definition interface to receive predefined conditions from a task payer, an artificial intelligence module to generate personalized recommendations, a validation engine to monitor real-time data including GPS coordinates and accelerometer data to generate validation signals, and a payment processing module to execute payments upon receipt of the validation signals. The system further includes multi-factor authentication token generation encapsulating task metadata, multi-gateway payment processing with fallback mechanisms supporting traditional currencies, cryptocurrencies, and non-monetary rewards, and real-time currency conversion for international transactions. A dynamic bidding engine supports open, sealed, and dynamic bidding with AI-driven bid analysis and bid success probability prediction. Fraud detection employs machine learning anomaly detection and clustering algorithms, an optional blockchain logger provides immutable transaction records, a user ranking engine evaluates performance and updates reputation scores, and visual evidence validation with embedded geolocation metadata enables proof-of-completion without physical inspection.

### CROSS-REFERENCE TO RELATED APPLICATIONS

This application claims priority to U.S. Provisional Patent Application No. 63/751,387, filed Jan. 30, 2025, the entire disclosure of which is incorporated herein by reference.

### FIELD OF THE INVENTION

The present disclosure relates to digital payment and reward systems, and more particularly to a mobile application platform that enables conditional payments, bonuses, incentive-based payments, and optional bidding.

### BACKGROUND OF THE INVENTION

Digital payment systems have experienced significant growth, transforming how individuals and businesses conduct financial transactions, including payments, tips, and incentives for service providers. Despite their prevalence, traditional payment, bidding, tipping, and reward systems exhibit inefficiencies, scalability limitations, and lack flexibility for evolving user needs.

### SUMMARY OF THE INVENTION

A system for facilitating conditional payments and bidding comprises a task definition interface configured to receive from a task payer one or more predefined conditions associated with a task; an artificial intelligence module configured to analyze the one or more predefined conditions and to generate personalized recommendations for the task payer or a task performer; a validation engine configured to monitor real-time data associated with the performance of the task and to analyze the real-time data against the one or more predefined conditions to generate a validation signal indicating that the task performer satisfied the conditions of the task; and a payment processing module configured to execute a conditional payment to the task performer only upon receiving the validation signal from the validation engine. The predefined conditions include at least one of a time constraint for completion of the task or a task completion requirement, and the real-time data can include GPS coordinates and accelerometer data from a device associated with the task performer.

In certain embodiments, the system further includes a photo and video capture module to receive visual evidence of task performance from the task performer, where the validation engine is configured to validate the visual evidence as part of satisfying the predefined conditions. The validation engine can detect potentially fraudulent transactions by analyzing real-time data using statistical and machine learning models, including clustering techniques to group normal transactions and isolate outliers. The payment processing module can be implemented as a multi-gateway payment processor supporting multiple payment methods such as traditional currencies, cryptocurrencies, and non-monetary rewards, and can include a fallback controller configured to reroute conditional payments upon primary payment method failure.

In some embodiments, the system further comprises a dynamic bidding engine configured to receive bids from a plurality of potential task performers, where the artificial intelligence module analyzes bids and provides recommendations to the task payer. A user ranking engine evaluates task payers and performers based on adherence to predefined conditions and transaction feedback, and dynamically updates reputation scores. Additional components may include an on-chain logger configured to record transaction details, including validation signals, on an immutable distributed ledger, and a multi-factor authentication token integration module that generates a unique, machine-readable token associated with the conditional payment and encapsulating task metadata and conditions.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating a system 100 comprising a conditional transaction interface 101, MFA generator 102, AI module 103, payment processor 104, and fraud detection system 105.

FIG. 2 is a block diagram of a bidding workflow system 200 including a bid creation interface 201, MFA scanner 202, bidding engine 203 including an open bidding module 204, a sealed bidding module 205, and a dynamic bidding module 206, an AI recommendation system 207, and a winner selection module 208.

FIG. 3 is a flowchart illustrating a fraud detection flow 300 including transaction data collection 301, feature extraction 302, anomaly scoring 303, threshold comparison 304, and fraud flag 305.

FIG. 4 is a flowchart illustrating a recommendation process 400 including historical data analysis 401, contextual data integration 402, model inference 403, and recommendation output 404.

FIG. 5 is a flowchart illustrating a performance evaluation flow 500 including performance data collection 501, metric weighting 502, score calculation 503, and ranking update 504.

FIG. 6 is a block diagram illustrating a fraud detection system 600 including a transaction monitoring unit 601, a pattern analysis unit 602, a clustering unit 603, historical transaction logs 604, and an alert generation unit 605.

FIG. 7 is a flowchart illustrating a payment processing workflow 700 including payment initiation 701, gateway selection 702, transaction execution 703, threshold comparison 704, confirmation 705, and fallback activation 706.

FIG. 8 is a flowchart illustrating a bidding process 800 including bid submission 801, AI analysis 802, recommendation generation 803, winner determination 804, and payment trigger 805.

FIG. 9 is a flowchart illustrating an MFA generation flow 900 including transaction initiation 901, metadata encapsulation 902, encryption 903, and token generation 904.

FIG. 10 is a block diagram illustrating a user ranking system 1000 including performance evaluation 1001, feedback integration 1002, score adjustment 1003, and ranking display 1004.

FIG. 11 is a flowchart illustrating a blockchain logging process 1100 including transaction validation 1101, data hashing 1102, block creation 1103, and chain addition 1104.

FIG. 12 is a flowchart illustrating a smart contract execution flow 1200 including condition definition 1201, real-time monitoring 1202, condition check 1203, and automatic execution 1204.

FIG. 13 is a flowchart illustrating a risk assessment flow 1300 including data collection 1301, threat analysis 1302, vulnerability scoring 1303, and risk mitigation 1304.

FIG. 14 is a flowchart illustrating a response handling flow 1400 including incident detection 1401, assessment 1402, response execution 1403, and review 1404.

FIG. 15 is a flowchart illustrating a response evaluation 1500 including an evaluation decision point that branches to approve 1501, modify 1502, or reject 1503.

FIG. 16 is a flowchart illustrating a localization module 1600 including user preference detection 1601, content adaptation 1602, language translation 1603, and currency conversion 1604.

FIG. 17 is a flowchart illustrating an enforcement flow 1700 including policy verification 1701, compliance assessment 1702, enforcement action 1703, and review outcome 1704.

FIG. 18 is a flowchart illustrating a system update flow 1800 including update check 1801, patch download 1802, installation 1803, and validation 1804.

FIG. 19 is a block diagram illustrating a location and motion validation subsystem 1900 including GPS input 1901, accelerometer input 1902, geofence validator 1903, and condition matcher 1904.

FIG. 20 is a block diagram illustrating a proof-of-completion and visual evidence validation subsystem 2000 including photo/video capture 2001, geolocation metadata binding 2002, evidence validator 2003, and AI image analysis 2004.

FIG. 21 is a block diagram illustrating an encryption and key management subsystem 2100 including key derivation 2101, encryption engine 2102, verification module 2103, and lifecycle manager 2104.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

Applicant has realized that conventional payment systems generally rely on static mechanisms that do not adapt to task-specific metrics or user-defined conditions, and often provide only predefined tipping options that fail to account for task complexity, timeliness, or service quality. Existing platforms typically do not support dynamic, performance-based incentives or non-monetary rewards tailored to specific scenarios, nor do they permit users to configure conditional payments based on parameters such as deadlines, performance thresholds, or incremental milestones. Further drawbacks include inadequate location identification for determining country, currency, and confirmation of task completion at a specified location.

Moreover, Applicant has realized that traditional bidding systems commonly provide static bid submissions without robust mechanisms for bid adjustment or withdrawal in response to changing conditions or requirements. Such platforms often lack analytical tools to predict success probabilities or recommend optimal bidding strategies, and do not provide group bidding capabilities for collective resource pooling or collaborative participation.

Furthermore, Applicant has realized that fraud detection in current digital payment platforms is frequently implemented using rule-based filters and manual reviews, which can be inefficient and prone to high false-positive rates that burden reviewers and delay legitimate transactions. These rule-based approaches typically lack the capacity to adapt to evolving fraudulent patterns.

Finally, Applicant has realized that many platforms implement user rating and ranking systems to establish reliability and trust, generally by collecting numerical scores or written feedback after a transaction. This feedback contributes to a publicly visible reputation score, but existing mechanisms often fail to fully integrate conditional performance, fraud risk, and contextual factors in a comprehensive, data-driven manner.

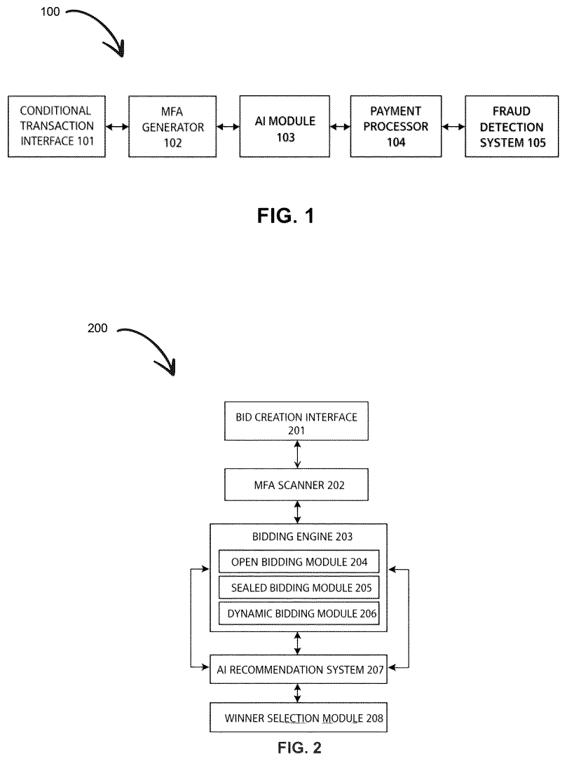

### FIG. 1—System Overview

As shown in FIG. 1, to which reference is now made, the present invention provides an innovative system 100 for conditional payments, dynamic bidding, and incentive-based transactions, constructed and operative in accordance with a preferred embodiment of the present invention. As described in more detail hereinbelow, system 100 may allow a user, such as a payer or a tipper, to create a payment or bonus offer with a set of conditions. As described in more detail hereinbelow, these conditions may be based on various metrics such as task performance, deadlines, and service quality. For example, a user may define conditions that include completing a task by a certain time, achieving a specific quality score, delivering a service to a verified geolocation, or reaching predefined milestones. System 100 may then monitor these conditions in real-time and automatically execute the payment upon their successful validation.

FIG. 1 illustrates system 100 comprising a conditional transaction interface 101, MFA generator 102, AI module 103, payment processor 104, and fraud detection system 105. The conditional transaction interface 101 is configured to receive task definitions and predefined conditions from a task payer. Conditional transaction interface 101 may serve as the primary point of interaction for users. Through this interface, a task payer may define and initiate various conditional transactions, including conditional payments, bonuses, and incentive-based rewards. Furthermore, a task payer may utilize conditional transaction interface 101 to create, customize, and submit bids for specific tasks or services, establishing it as the entry point for the system's bidding workflows.

The MFA generator 102 produces authentication tokens encapsulating task metadata. The AI module 103 analyzes conditions, historical data, and real-time inputs to generate recommendations. The payment processor 104 executes conditional payments upon validation, such as releasing a payment upon the fulfillment of a task's conditions or upon the successful conclusion of a bidding process, and the fraud detection system 105 monitors transactions for anomalies.

These components may interact to facilitate a range of secure, conditional transactions. For example, a user may initiate a conditional payment or a competitive bid via conditional transaction interface 101. MFA generator 102 may create a unique MFA for that transaction. AI module 103 may provide intelligent recommendations relevant to the transaction type. Upon the validation of all conditions, such as task completion or the selection of a winning bid, payment processor 104 may execute the financial transfer, while fraud detection system 105 may provide continuous monitoring throughout the process.

### FIG. 2—Bidding Workflow System

FIG. 2 shows a bidding workflow system 200 in which users initiate bids via bid creation interface 201. An MFA scanner 202 authenticates participants prior to bid submission. A bidding engine 203 includes an open bidding module 204 for transparent auctions, a sealed bidding module 205 for confidential submissions, and a dynamic bidding module 206 for real-time bid adjustments. An AI recommendation system 207 analyzes bids, conditions, and trends to provide suggestions, and a winner selection module 208 determines the successful participant based on predefined criteria and recommendations.

Upon winner selection module 208 determining an outcome, it may trigger payment processor 104 (FIG. 1) to handle the subsequent financial transaction. The entire process within bidding workflow system 200 may be monitored for suspicious activity by fraud detection system 105 (FIG. 1) to ensure transactional integrity.

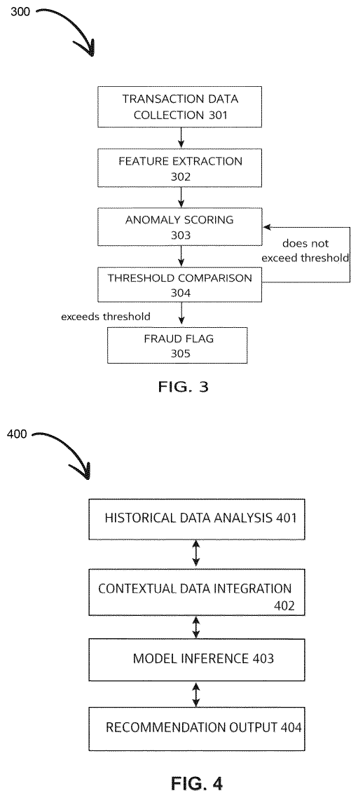

### FIG. 3—Fraud Detection Flow

FIG. 3 depicts a fraud detection flow 300 including transaction data collection 301 to gather input records. Feature extraction 302 derives relevant attributes for analysis. Anomaly scoring 303 computes risk values using statistical and machine learning models. Threshold comparison 304 determines whether the computed risk exceeds an acceptable limit, and when exceeded, a fraud flag 305 is generated and transmitted for review or blocking.

Feature extraction 302 derives the following feature categories from transaction data for anomaly scoring: (a) Transactional Features including transaction amount, transaction frequency (transactions per hour/day), average transaction value over rolling windows (7-day, 30-day), deviation from user's historical average, and payment method identifier; (b) Temporal Features including time of day (encoded as sine/cosine for cyclical representation), day of week, time since last transaction, and transaction velocity (number of transactions within configurable time windows of 1 minute, 5 minutes, and 1 hour); (c) Device and Location Features including device fingerprint hash, IP address geolocation, GPS coordinates (when available), distance from user's typical transaction locations, and device change frequency; and (d) Behavioral Features including user reputation score from ranking system 1000, historical fraud flag rate, session duration, and navigation pattern hash. Numerical features are normalized using min-max scaling or z-score normalization based on historical distributions. Categorical features (e.g., payment method, device type) are encoded using one-hot encoding or target encoding. Missing values are imputed using median values for numerical features and mode values for categorical features. Feature vectors are assembled into fixed-length arrays for model input.

### FIG. 4—Recommendation Process

FIG. 4 illustrates a recommendation process 400. Historical data analysis 401 reviews past transactions and user behaviors. Contextual data integration 402 incorporates current situational factors. Model inference 403 applies trained models to the combined data, and recommendation output 404 delivers personalized suggestions to task payers or performers.

This final recommendation may be presented to the user on conditional transaction interface 101 to assist in setting payment or tip amounts. In the context of bidding workflow system 200 (FIG. 2), this same process may be utilized by AI recommendation system 207 to provide suggestions for optimizing bid amounts.

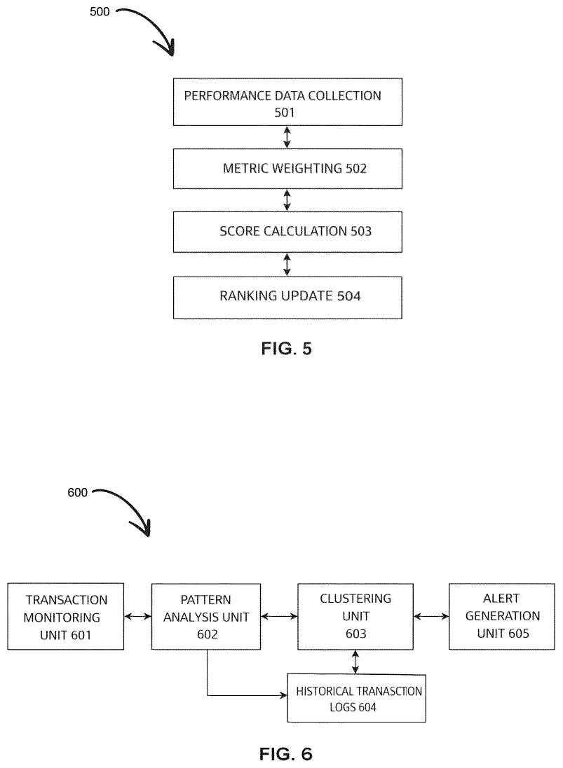

### FIG. 5—Performance Evaluation Flow

FIG. 5 shows a performance evaluation flow 500. Performance data collection 501 gathers objective metrics related to task execution. Metric weighting 502 assigns relative importance to each metric. Score calculation 503 computes an overall performance value, and ranking update 504 adjusts user reputation scores accordingly.

Score calculation 503 computes an aggregate performance score using a weighted linear combination of normalized metrics. The formula is:

PerformanceScore=Σ(wi×ni)/Σ(wi),

where wi is the weight assigned to metric i and ni is the normalized value of metric i (scaled to 0-1 range). Metric definitions include: Timeliness Score calculated as 1 minus the minimum of 1 or (actual_completion_time minus deadline) divided by grace_period for late completions, with a value of 1.0 for on-time completions and an optional bonus multiplier for early completion. Quality Score is derived from AI image analysis confidence scores, aggregated customer ratings, or objective measurements against task specifications. Compliance Score is either binary (1.0 if all predefined conditions met, 0.0 otherwise) or proportional (fraction of conditions satisfied). Default weights are timeliness=0.3, quality=0.4, compliance=0.3. Weights can be customized per task category through the task definition interface. Machine learning models (gradient boosted regressors) may dynamically adjust weights based on historical correlation between metric combinations and customer satisfaction outcomes.

### FIG. 6—Fraud Detection System

FIG. 6 depicts a fraud detection system 600 comprising a transaction monitoring unit 601 that continuously observes activity streams. A pattern analysis unit 602 identifies behavioral signatures, and a clustering unit 603 groups similar transactions to establish baselines. Historical transaction logs 604 provide reference data for comparison. An alert generation unit 605 issues notifications when anomalies are detected. Clustering unit 603 applies clustering algorithms, including k-means, DBSCAN, or hierarchical clustering, to segment transactions into clusters of normal behavior based on learned historical patterns, thereby isolating outlier transactions that fall outside established clusters and deviate significantly from behavioral norms. Such outliers are identified as potential fraudulent activity and forwarded to an alert generation unit for severity scoring and review.

Pattern analysis unit 602 employs a multi-stage detection pipeline. The first stage applies rule-based filters for known fraud signatures (e.g., transaction amount exceeding 3 standard deviations from user mean, rapid successive transactions from geographically distant locations). The second stage feeds the feature vector to trained machine learning models. For unsupervised detection, isolation forest models are configured with contamination parameter set to the expected fraud rate (typically 0.01-0.05) and trained on historical legitimate transactions. Auto-encoder models are trained to reconstruct normal transaction patterns, with reconstruction error serving as the anomaly score. Transactions with anomaly scores exceeding a configurable threshold (calibrated to achieve target precision/recall based on labeled validation data) are flagged for review or blocking.

In one or more embodiments, AI module 103 may employ machine learning models for fraud detection, recommendations, and performance evaluation. For fraud detection, the machine learning models may include, without limitation, unsupervised anomaly detection techniques, such as isolation forests or auto-encoders, to isolate deviations from normal behavior. These models may be trained using historical transaction logs 604, with feature vectors composed of transactional, temporal, device, location, and behavioral attributes. Feature extraction includes normalization and temporal calculations.

For recommendations, the machine learning models may be supervised regression models, such as gradient boosted trees or feed-forward neural networks, trained on labeled historical/contextual data to generate personalized suggestions. For performance evaluation, supervised regression models or learning-to-rank algorithms, such as “LambdaMART”, dynamically weight timeliness, quality, compliance, and other configurable metrics from historical performance data.

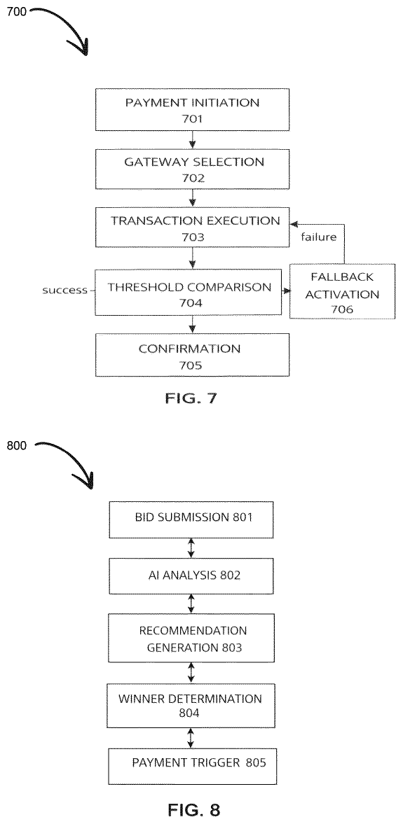

### FIG. 7—Payment Processing Workflow

FIG. 7 illustrates a payment processing workflow 700. Payment initiation 701 begins upon receipt of a validation signal. Gateway selection 702 chooses an appropriate payment processor among available methods. Transaction execution 703 attempts processing via the selected gateway. Threshold comparison 704 evaluates success criteria, confirmation 705 finalizes approved payments, and fallback activation 706 reroutes processing to an alternative gateway upon primary gateway failure. Gateway selection 702 selects among supported payment methods including: (a) traditional fiat processors such as credit card networks, ACH, and wire transfers; (b) cryptocurrency gateways capable of processing blockchain-based digital assets; and (c) non-monetary reward processors issuing platform-specific points, tokens, service credits, or incentive instruments. Selection logic 702 may consider transaction cost, speed, user preference, currency availability, and regulatory compliance.

### FIG. 8—Bidding Process

FIG. 8 shows a bidding process 800. Bid submission 801 receives offers from participants. AI analysis 802 evaluates submissions against predefined conditions and market factors. Recommendation generation 803 provides guidance to the task payer, and winner determination 804 selects the successful party. Payment trigger 805 initiates settlement upon selection.

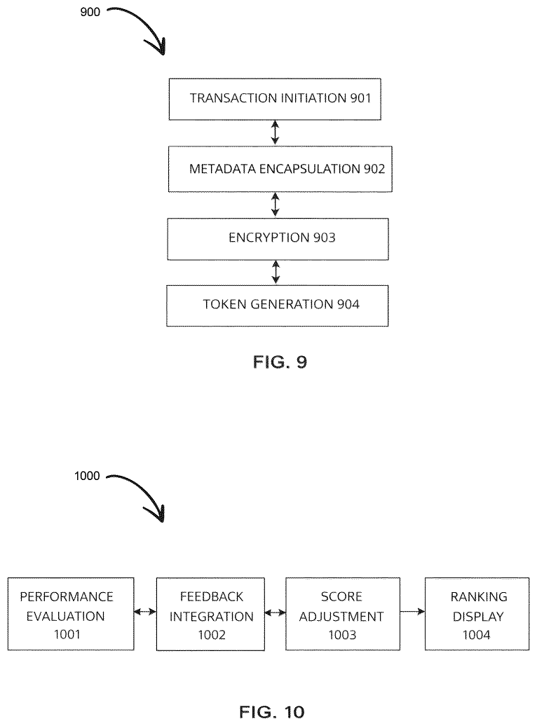

### FIG. 9—MFA Generation Flow

FIG. 9 depicts an MFA generation flow 900. Transaction initiation 901 starts the authentication sequence. Metadata encapsulation 902 embeds task-specific information into a token structure. Encryption 903 secures the encapsulated data. Token generation 904 produces a final machine-readable authentication token.

Token generation 904 produces a machine-readable token with the following structure, subsequently encrypted and encoded: The token includes a token_id field containing a UUID v4 string, a version field (e.g., “1.0”), a task_id field containing the unique task identifier, a payer_id field containing the unique payer account identifier, a performer_id field containing the unique performer account identifier (nullable until assigned), a conditions array containing objects with condition_id, type (enumerated as LOCATION, TIME, COMPLETION, QUALITY, or CUSTOM), parameters (condition-specific key-value pairs), and required (boolean), a payment object containing amount (decimal string), currency (ISO 4217 currency code or cryptocurrency symbol), and escrow_address (payment processor escrow reference, nullable), a timestamps object containing created_at, expires_at, and deadline (all ISO 8601 datetime format), and a signature field containing an HMAC-SHA256 or ECDSA signature of the canonical token content. The token is serialized to JSON, signed using the system's private key (ECDSA with P-256 curve or HMAC-SHA256 with server secret), encrypted using AES-256-GCM with a derived key, and encoded as Base64 for transmission. QR code generation uses the encoded token string with error correction level H for machine scanning.

The following API definitions describe the interfaces between system components.

Task Definition Interface API (Conditional Transaction Interface 101): The Create Task Endpoint (POST/api/v1/tasks) accepts a request body containing title (string), description (string), conditions (array of objects each containing type enumerated as LOCATION, TIME, COMPLETION, or QUALITY, and parameters as key-value pairs), and payment (object containing amount as decimal, currency as string, and method enumerated as FIAT, CRYPTO, or REWARD). The response contains task_id (string), mfa_token (string), and status set to CREATED.

Validation Engine Signal API: The Submit Validation Data Endpoint (POST/api/v1/tasks/{task_id}/validate) accepts a request body containing performer_id (string), evidence object (containing gps object with latitude, longitude, accuracy_meters, and timestamp; accelerometer array of objects with x, y, z values and timestamps; and images array of objects with base64-encoded data, mime_type, and capture_timestamp), and mfa_token (string). The response contains validation_id (string), status (enumerated as PENDING, APPROVED, or REJECTED), and validation_signal object (containing all_conditions_met boolean and condition_results array).

Payment Processor Trigger API: The Execute Payment Endpoint (POST/api/v1/payments/execute) accepts a request body containing task_id, validation_id, validation_signal object, recipient_id, amount, currency, and gateway_preference (enumerated as AUTO, FIAT, CRYPTO, or REWARD). The response contains payment_id (string), status (enumerated as PROCESSING, COMPLETED, or FAILED), gateway_used (string), and transaction_reference (string).

### FIG. 10—User Ranking System

FIG. 10 illustrates a user ranking system 1000. Performance evaluation 1001 assesses objective task outcomes. Feedback integration 1002 incorporates subjective user input from counterparties. Score adjustment 1003 updates numerical reputation values based on combined inputs, and ranking display 1004 presents current reputation scores to users.

Score adjustment 1003 updates user reputation scores using an exponential moving average that balances historical performance with recent transactions:

NewReputation=α×CurrentTransactionScore+(1−α)×PreviousReputation,

where α (learning rate) is typically set between 0.1 and 0.3, configurable based on desired responsiveness to recent performance. Transaction scores are derived from the performance evaluation flow 500. Additional adjustments include: dispute rate penalty (reputation reduced proportionally to upheld disputes), longevity bonus (small positive adjustment for accounts with extended positive history), and category-specific sub-scores for users active in multiple task types.

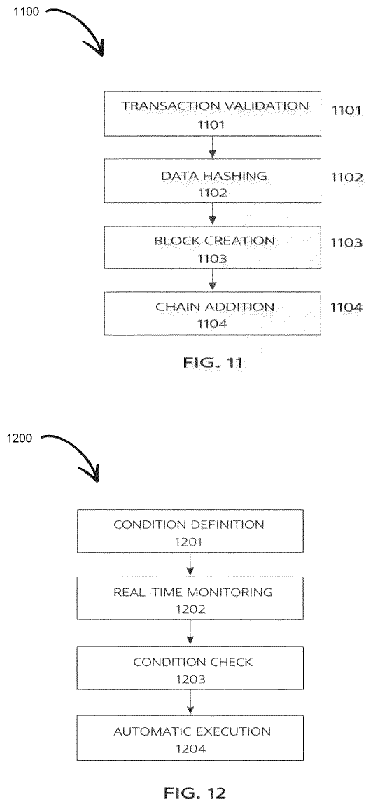

### FIG. 11—Blockchain Logging Process

FIG. 11 shows a blockchain logging process 1100. Transaction validation 1101 confirms the integrity and authenticity of incoming data. Data hashing 1102 generates a cryptographic digest of validated transaction details. Block creation 1103 assembles the digest into a new block with a timestamp and a reference to a prior block. Chain addition 1104 appends the completed block to an immutable distributed ledger to ensure permanent and tamper-evident recording.

### FIG. 12—Smart Contract Execution Flow

FIG. 12 depicts a smart contract execution flow 1200. Condition definition 1201 establishes programmable rules and thresholds. Real-time monitoring 1202 observes external data streams for compliance. Condition check 1203 evaluates whether monitored data satisfies defined rules. Automatic execution 1204 triggers predefined actions, such as payment release, when conditions are met. The system may optionally integrate with blockchain platforms via smart contracts that automatically execute conditional payment upon receipt of a validation signal, providing tamper-evident enforcement of predefined conditions.

The optional smart contract module for blockchain-based enforcement may be implemented as a set of smart contracts deployed on EVM-compatible blockchains (e.g., Ethereum, Polygon, Avalanche). The primary contract maintains an escrow of funds deposited by the task payer upon task creation. The contract exposes functions to: (a) create a task with escrowed payment and hashed condition parameters; (b) receive validation signals from an authorized oracle (the validation engine operating through a secure oracle bridge); (c) automatically release escrowed funds to the performer upon receipt of a positive validation signal; and (d) refund the payer if the task deadline expires without successful validation. The contract emits events for each state transition, which are captured by blockchain logging process 1100 for immutable record-keeping. Integration with the payment processing workflow 700 occurs via gateway selection 702, which can select the smart contract as the payment execution mechanism when blockchain-based enforcement is enabled for the task.

The smart contract module implements the following functions for blockchain-based conditional payment enforcement: A create task function that accepts task Id, performer address, conditions hash, and deadline parameters, and is called with payment value to create escrow for the conditional payment. A report validation function that accepts task Id, conditions met Boolean, and proof parameters, callable only by the authorized oracle address (the validation engine), which reports the validation result to the contract. An internal release payment function that transfers escrowed funds to the performer's address upon successful validation. A claimRefund function that allows the payer to reclaim funds if the deadline passes without successful validation. The contract maintains a mapping of task structures containing payer address, performer address, payment amount, conditions hash, deadline timestamp, and boolean flags for validated and paid status. The validation engine acts as an oracle, calling report validation with the task identifier and validation result. The smart contract verifies the caller is the authorized oracle, checks that the task exists and is not already paid, and if conditions met is true, transfers the escrowed funds to the performer's address. Events are emitted for task creation, validation receipt, and payment execution to enable off-chain monitoring and integration with blockchain logging process 1100.

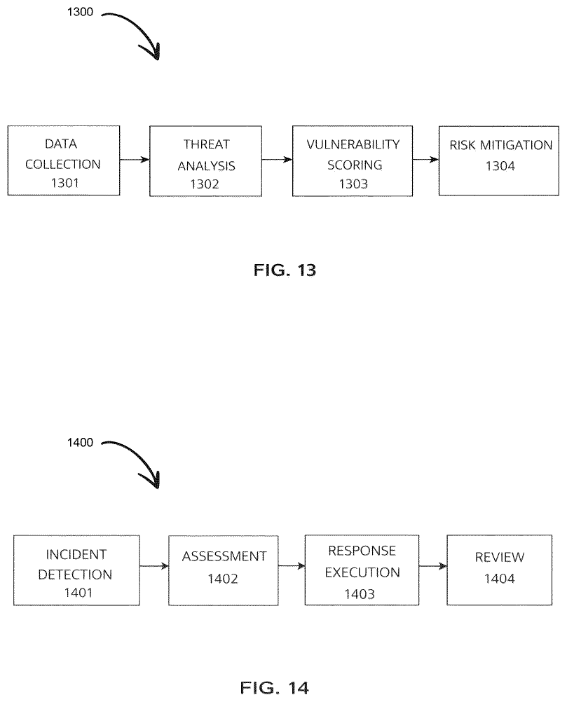

### FIG. 13—Risk Assessment Flow

FIG. 13 illustrates a risk assessment flow 1300. Data collection 1301 gathers relevant inputs from transactions and environmental sources. Threat analysis 1302 identifies potential attack vectors. Vulnerability scoring 1303 quantifies exposure levels, and risk mitigation 1304 applies controls or alerts to reduce identified risks.

### FIG. 14—Response Handling Flow

FIG. 14 shows a response handling flow 1400. Incident detection 1401 identifies anomalies or security events. Assessment 1402 evaluates severity and scope. Response execution 1403 implements containment or remediation measures. Review 1404 documents outcomes and derived lessons.

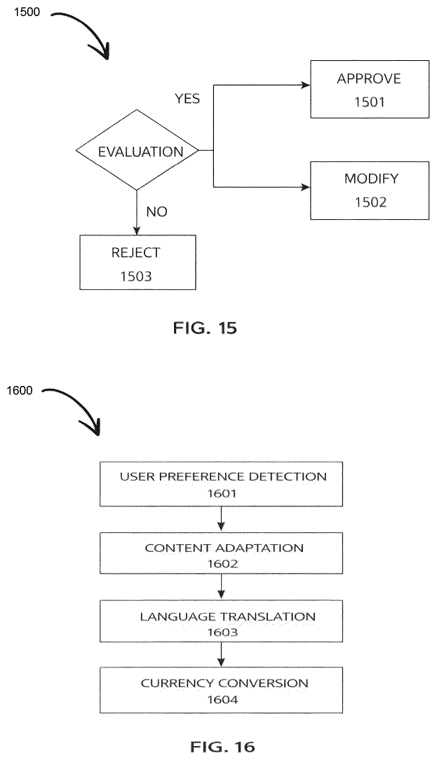

### FIG. 15—Response Evaluation

FIG. 15 depicts a response evaluation 1500. An evaluation decision point assesses submitted responses or evidence. The flow branches to approve 1501 when criteria are fully satisfied, to modify 1502 when partial compliance requires adjustment, or to reject 1503 when requirements are not met.

### FIG. 16—Localization Module

FIG. 16 illustrates a localization module 1600. User preference detection 1601 identifies regional and language settings. Content adaptation 1602 customizes presentation for local norms. Language translation 1603 converts text to a preferred language, and currency conversion 1604 adjusts monetary values to local currency.

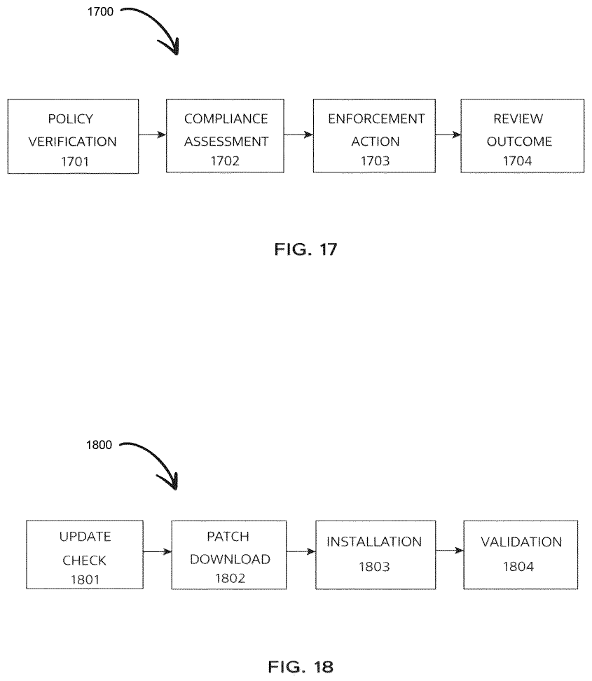

### FIG. 17—Enforcement Flow

FIG. 17 shows an enforcement flow 1700. Policy verification 1701 confirms applicable rules. Compliance assessment 1702 evaluates adherence to those rules. Enforcement action 1703 applies penalties or remedies in case of non-compliance, and review outcome 1704 documents the final disposition.

### FIG. 18—System Update Flow

FIG. 18 depicts a system update flow 1800. Update check 1801 queries for available patches. Patch download 1802 retrieves approved updates. Installation 1803 applies patches to the running system, and validation 1804 confirms successful application and integrity.

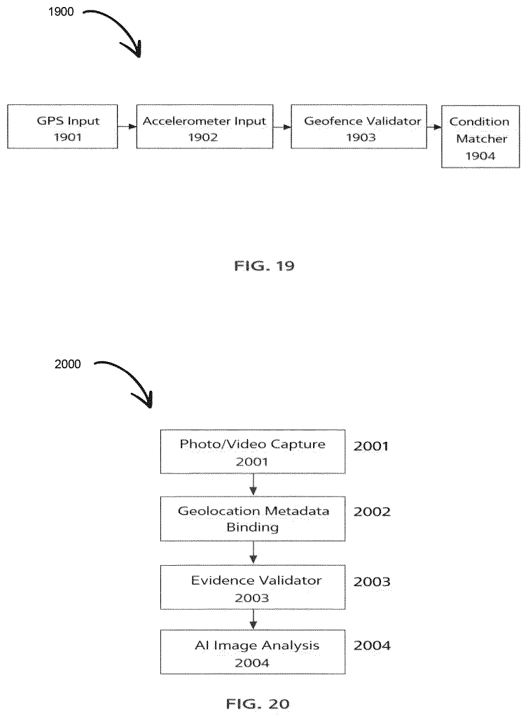

### FIG. 19—Location and Motion Validation Subsystem

FIG. 19 illustrates a location and motion validation subsystem 1900. A GPS input 1901 receives coordinate data from a device associated with the task performer. An accelerometer input 1902 captures motion patterns from the device. A geofence validator 1903 determines whether the coordinates fall within predefined geographic boundaries. A condition matcher 1904 compares the combined GPS, accelerometer, and geofence results against the task's predefined location and motion conditions to generate a compliance signal for further processing.

Condition matcher 1904 evaluates task conditions using the following validation logic: For GPS Validation, the condition matcher compares received coordinates against the task's predefined location using the Haversine formula to calculate distance, with a condition passing if the calculated distance is within the configured tolerance radius (e.g., 50 meters for delivery tasks, 10 meters for precise location tasks); multiple GPS readings may be averaged to reduce noise, with outliers (readings exceeding 3 standard deviations from the rolling mean) discarded. For Accelerometer Pattern Validation, the condition matcher analyzes accelerometer data streams to detect specific patterns: stationary verification requires variance of accelerometer magnitude below threshold (e.g., less than 0.1 m/s²) over configurable duration; movement verification requires accelerometer magnitude exceeding threshold (e.g., greater than 1.0 m/s²) with periodic patterns indicating walking (1-2 Hz frequency) or driving (lower frequency, higher magnitude); activity classification uses pre-trained activity recognition models (trained on labeled accelerometer datasets such as UCI HAR) to classify movement type (walking, running, driving, stationary) with confidence scores. For Geofence Validation, geofence validator 1903 implements point-in-polygon testing using the ray casting algorithm for polygonal geofences, or distance calculation for circular geofences, with entry/exit events timestamped and dwell time computed against minimum duration requirements. For Composite Condition Evaluation, the condition matcher evaluates all applicable conditions and generates a binary compliance signal (all conditions met) or a detailed compliance report (per-condition pass/fail with confidence scores) depending on configuration.

### FIG. 20—Proof-of-Completion and Visual Evidence Validation Subsystem

FIG. 20 depicts a proof-of-completion and visual evidence validation subsystem 2000. Photo/video capture 2001 records visual evidence of task performance using the performer's device. Geolocation metadata binding 2002 embeds capture-location coordinates into the visual file. An evidence validator 2003 authenticates the integrity of the file and embedded metadata. An AI image analysis component 2004 evaluates visual content against the task's predefined completion criteria and produces a validation output confirming both location authenticity and task fulfillment. An AI image analysis component evaluates visual content using convolutional neural networks or other trained image classification models to assess task completion criteria such as object presence, location accuracy, or quality standards.

AI image analysis component 2004 employs image recognition to authenticate visual evidence through AI image analysis component 2004. The image recognition system utilizes convolutional neural networks (CNNs) with architectures such as Res-net, Efficient-Net, or Mobile-Net, selected based on accuracy/latency tradeoffs for the deployment environment. Models are trained on task-category-specific datasets containing labeled examples of valid and invalid completion evidence. During inference, the captured image is preprocessed (resized, normalized), passed through the CNN to generate feature embeddings, and processed by classification heads that output confidence scores for relevant criteria (e.g., object presence, location accuracy, quality compliance). The validation engine compares these confidence scores against predefined thresholds specified in the task conditions. For example, a delivery task may require “package visible” confidence greater than 0.90 and “address readable” confidence greater than 0.85. Multi-class classification or object detection variants (using architectures like YOLO or Faster R-CNN) may be employed for tasks requiring identification of specific objects within the image.

For delivery verification, datasets include images of packages at doorsteps with labels indicating presence/absence of package, correct/incorrect address visibility, and image quality scores. For service completion (e.g., cleaning, maintenance), datasets include before/after image pairs with quality ratings on a 1-5 scale provided by human annotators. Dataset sizes typically range from 10,000 to 100,000 labeled images per task category, with 80/10/10 train/validation/test splits. Subjective quality metrics are converted to quantitative labels through multi-annotator consensus, where each image is rated by at least three human annotators and the final label is the median score. Inter-annotator agreement (Cohen's kappa) is monitored, and images with low agreement are reviewed or excluded. Quality dimensions include:-image clarity (blur detection via Laplacian variance), lighting adequacy (histogram analysis), object completeness (bounding box coverage), and task-specific criteria defined in the task configuration. During inference, captured images are preprocessed (resized to model input dimensions, normalized to model-specific mean/standard deviation values), passed through the CNN to extract feature embeddings, and classified by task-specific output heads. The model outputs confidence scores for each criterion (e.g., “package present: 0.94”, “address visible: 0.87”). Validation passes when all required criteria exceed their configured confidence thresholds.

Geolocation metadata binding 2002 embeds capture-location coordinates into visual evidence using a dual-layer approach for security and tamper-evidence. Layer 1 (EXIF Metadata Embedding): GPS coordinates, altitude, timestamp, and device identifier are written to the image file's EXIF metadata fields (GPS-Latitude, GPS-Longitude, GPS-Altitude, GPS-TimeStamp, GPS-Date Stamp) at the moment of capture, before the image leaves the capture module; this provides standard metadata readable by common image tools. Layer 2 (Cryptographic Binding): A separate metadata record is created containing the image-hash (SHA-256 hash of original image bytes), gps-latitude, gps-longitude, gps-accuracy (in meters), capture-imige-tamp (ISO 8601 with milliseconds), device-id, and sensor-data-hash (SHA-256 hash of concurrent accelerometer/gyroscope readings). This record is digitally signed using the device's private key (stored in secure enclave/TEE where available) or an application-level key. The signature is computed as ECDSA-P256 over SHA-256 of the canonical JSON record. The signed metadata record is stored separately from the image and transmitted alongside it. Evidence validator 2003 verifies tamper-evidence by: (1) recomputing the SHA-256 hash of the received image and comparing against the signed metadata's image-hash field; (2) verifying the digital signature using the device's registered public key; (3) checking timestamp plausibility against server receipt time; and (4) optionally comparing EXIF metadata against the signed record for consistency. Any mismatch indicates potential tampering and triggers rejection or manual review.

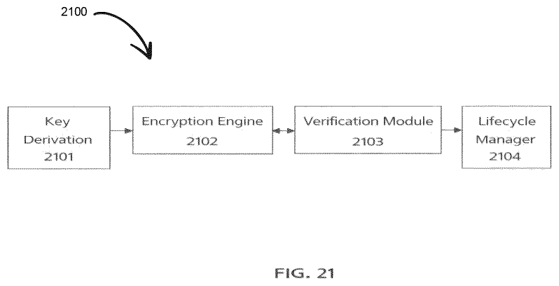

### FIG. 21—Encryption and Key Management Subsystem

FIG. 21 illustrates an encryption and key management subsystem 2100. Key derivation 2101 generates cryptographic material from secure inputs. An encryption engine 2102 applies encryption to transaction data, validation signals, and metadata. A verification module 2103 authenticates data integrity and origin through signature checks. A lifecycle manager 2104 controls key rotation, expiration, and revocation, with bidirectional interaction between the encryption engine 2102 and verification module 2103 to ensure continuous secure operation.

It will be appreciated that conditional payment system 100 may synergistically integrate multiple processes to create a novel and cohesive conditional transaction ecosystem. The present invention synergistically integrates three key areas: conditional logic, enabling users to define complex conditions based on factors such as performance, time, location, and quality; artificial intelligence (AI), which utilizes machine learning to provide recommendations, evaluate performance, detect fraud, and optimize outcomes; and multi-modal verification, which leverages real-world data from sensors like GPS and accelerometers, user-provided evidence such as photos and videos, and secure authentication methods like MFA to validate that the defined conditions have been met.

It will be appreciated that conditional payment and bidding system 100 may be industry-agnostic and may be adaptable to a diverse range of real-world use cases. The following examples are illustrative only.

In the healthcare sector, system 100 may be utilized by medical insurance companies to provide conditional rewards to patients for compliance with prescribed treatment plans or for achieving specific health outcomes, such as maintaining a target blood glucose level. This framework incentivizes preventative care and can also be used to reward healthcare providers for facilitating positive patient outcomes.

In the trucking and transportation sector, system 100 may facilitate the allocation of tiered bonuses or tips to a group of workers at a warehouse or offloading facility. Conditions may be based on the speed of task completion and compliance with predefined timelines, thereby incentivizing efficiency, reducing logistical downtime, and ensuring transparency in payments.

In the education sector, parents or students may set conditional payments for tutors based on achieving improved test scores, timely coursework completion, or other specific learning objectives. This aligns the goals of educators and learners, fostering accountability and driving measurable success.

In retail and merchandising, a company may set conditional payments for merchandisers who achieve superior display standards or meet sales targets. Verification can be achieved through evidence such as photos, videos, and geolocation data, which is then analyzed by the AI module to ensure fair and appropriate reward distribution.

In freelance marketplaces, a client may hire a freelancer and set conditional payments tied to project milestones, such as draft submission, revisions, and final delivery. System 100 may generate a unique MFA token encapsulating these conditions, and AI module 103 may suggest tip amounts based on the freelancer's historical performance, with payment released automatically upon validated completion of each milestone.

In construction and contract work, a contractor may use system 100 to submit sealed bids with cost breakdowns and deadlines. A unique MFA may link the bid to contractual terms, and payments can be released incrementally as verified milestones are achieved.

In event management, a group of attendees may pool funds for a community event. The group bidding feature of system 100 may enable payers to collectively set conditions for vendors, such as for catering quality or event timing. Funds may then be distributed automatically upon condition validation, with MFA tracking individual contributions and expenses.

Unless specifically stated otherwise, as apparent from the preceding discussions, it is appreciated that, throughout the specification, discussions utilizing terms such as “analyzing,” “generating,” “processing,” “computing,” “calculating,” “determining,” or the like, refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

The inventive elements discussed hereinabove may be implemented on a suitable apparatus. This apparatus may be specially constructed for the desired purposes, or it may comprise a computing device or system typically having at least one processor and at least one memory, selectively activated or reconfigured by a computer program, code or prompt. The resultant apparatus when instructed by program, code or prompt may turn the general purpose computer into inventive elements as discussed herein. The program, code or prompt may define the inventive device in operation with the computer platform for which it is desired. Such program, code or prompt may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing programs, code or prompts. The computer readable storage medium may also be implemented in cloud storage.

Some general purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any, specific programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system for facilitating conditional payments and bidding, comprising:
a task definition interface configured to receive from a task payer one or more predefined conditions associated with a task;
an artificial intelligence module configured to analyze the one or more predefined conditions and to generate personalized recommendations for the task payer or a task performer;
a validation engine configured to monitor real-time data associated with performance of the task and to analyze the real-time data against the one or more predefined conditions to generate a validation signal indicating that the task performer satisfied the conditions of the task; and
a payment processing module configured to execute a conditional payment to the task performer only upon receiving the validation signal from the validation engine.

2. The system of claim 1, wherein the one or more predefined conditions comprise at least one of a time constraint for completion of the task or a task completion requirement.

3. The system of claim 1, wherein the real-time data monitored by the validation engine comprise at least one of GPS coordinates or accelerometer data from a device associated with the task performer.

4. The system of claim 3, further comprising a photo and video capture module configured to receive visual evidence of task performance from the task performer, wherein the validation engine is further configured to validate the visual evidence as part of satisfying the one or more predefined conditions.

5. The system of claim 1, wherein the validation engine is further configured to identify potentially fraudulent transactions by analyzing the real-time data using statistical and machine learning models.

6. The system of claim 5, wherein the validation engine, when identifying potentially fraudulent transactions, further incorporates clustering techniques to group normal transactions and isolate outlier transactions.

7. The system of claim 1, wherein the payment processing module comprises a multi-gateway payment processor configured to support a plurality of payment methods including at least one of traditional currencies, cryptocurrencies, or non-monetary rewards.

8. The system of claim 7, wherein the multi-gateway payment processor further comprises a fallback controller configured to monitor an operational status of the plurality of payment methods and to reroute the conditional payment in an event of a primary payment method failure.

9. The system of claim 1, further comprising a dynamic bidding engine configured to receive bids from a plurality of potential task performers for the task, wherein the artificial intelligence module is further configured to analyze the bids and provide a recommendation to the task payer.

10. The system of claim 1, further comprising a user ranking engine configured to evaluate the task payer and the task performer based on adherence to the one or more predefined conditions and transaction feedback, and to dynamically update a reputation score for each of the task payer and the task performer.

11. The system of claim 1, further comprising an on-chain logger configured to record transaction details, including the validation signal from the validation engine, onto an immutable distributed ledger.

12. The system of claim 1, further comprising a multi-factor authentication token integration module configured to generate a unique, machine-readable MFA token associated with the conditional payment, the MFA token encapsulating metadata corresponding to the task and the one or more predefined conditions.

13. The system of claim 9, wherein the dynamic bidding engine supports real-time bid adjustments based on changing market conditions or task requirements.

14. The system of claim 9, wherein the dynamic bidding engine enables collaborative group bidding, allowing multiple users to pool resources and set collective conditions.

15. The system of claim 1, wherein the artificial intelligence module uses historical data and real-time trends to predict bid success probabilities.

16. The system of claim 1, further comprising a smart contract module configured to provide optional blockchain-based enforcement of the conditional payment.

17. The system of claim 1, wherein the payment processing module includes real-time currency conversion for international transactions.

18. The system of claim 10, wherein the user ranking engine incorporates machine learning to weight feedback and performance metrics.

19. The system of claim 4, wherein the validation engine employs image recognition to authenticate the visual evidence.

20. The system of claim 1, further comprising a notification module configured to provide real-time updates on task progress and payment status.

21. The system of claim 1, wherein GPS and accelerometer data are utilized to validate service completion or compliance with predefined location-specific conditions and to enhance security.

22. The system of claim 3, wherein the validation engine comprises a location and motion validation subsystem comprising: a GPS input configured to receive coordinate data from a device associated with the task performer; an accelerometer input configured to capture motion data from the device; a geofence validator configured to determine compliance with predefined geographic boundaries; and a condition matcher configured to compare the received coordinate data, motion data, and geofence compliance against the one or more predefined conditions.

23. The system of claim 4, wherein the photo and video capture module and the validation engine together comprise a proof-of-completion and visual evidence validation subsystem comprising:
a photo/video capture component configured to record visual evidence of task performance;
a geolocation metadata binding component configured to embed geolocation coordinates indicating a capture location into the captured visual evidence; an evidence validator configured to authenticate integrity and origin of the visual evidence; and
an AI image analysis component configured to evaluate the visual content against the predefined conditions, wherein the evidence validator compares the capture location against a predefined task location.

24. The system of claim 1, further comprising an encryption and key management subsystem comprising:
a key derivation component configured to generate cryptographic material;
an encryption engine configured to secure transaction and validation data;
a verification module configured to authenticate data integrity and origin; and
a lifecycle manager configured to control key rotation and expiration.
